(19) United States
(12) Patent Application Publication
(10) Pub. No.: US 2024/0403469 A1
(43) Pub. Date: Dec. 5, 2024

(54) A Method, a Computer Program Product and a Device for Dynamic Spatial Anonymization of Vehicle Data in a Cloud Environment

(71) Applicant: Volkswagen Aktiengesellschaft, Wolfsburg (DE)

(72) Inventors: Sabina Alazzawi, München (DE); Chaitanya Kumar Dondapati, Pulzbrunn (DE); Richard Niestroj, München (DE); Pierpaolo Resce, Germering (DE)

(73) Assignee: Volkswagen Aktiengesellschaft, Wolfsburg (DE)

(21) Appl. No.: 18/697,690

(22) PCT Filed: Jan. 6, 2023
(86) PCT No.: PCT/EP2023/050245

§ 371 Date: Apr. 1, 2024

(30) Foreign Application Priority Data
Jan. 6, 2022 (EP) 22150434.3
Jan. 6, 2022 (EP) 22150435.0

(51) Int. Cl. G06F 21/62

(52) U.S. Cl. CPC G06F 21/6218

(57) ABSTRACT

The disclosure relates to a method for dynamic spatial anonymization of vehicle data in a cloud environment. The method may comprise: collecting vehicle data, spatial partitioning the vehicle data into data subset associated with different geographical areas of various sizes and comprising a maximal amount of records within each data subset, spatial aggregation of the vehicle data within the data subsets, providing two level aggregation, namely: aggregation of vehicle data, coming from a single vehicle, to a corresponding data point and aggregation data points, coming from a group of vehicles comprising a particular number of vehicles, to a spatial aggregated data set.

### CROSS-REFERENCE TO RELATED APPLICATIONS

This application claims priority to European Patent Application No. EP 22150434.3, filed on Jan. 6, 2022 with the European Patent and Trademark Office. This application also claims priority to European Patent Application No. EP 22150435.0, filed on Jan. 6, 2022 with the European Patent and Trademark Office. The contents of the aforesaid patent applications are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure is related to a method for dynamic spatial anonymization of vehicle data in a cloud environment. Further, the disclosure is related to a corresponding computer program product. Furthermore, the disclosure is related to a corresponding device, especially backend device.

Real-time vehicular data plays a key role in current data driven projects. Typical use cases concerned with the analysis of vehicular information extracted from installed sensors include, e.g., the creation of maps providing parking or weather information. The displayed information thereby may be a result of advanced analytics including, in particular, forecasts that can be in return consumed by the vehicle.

Due to in-car computational constraints, advanced analytics usually take place in a cloud environment. Thus, the sensor data is extracted and shared with a cloud platform. This approach requires, however, the anonymization of the extracted data due to data protection requirements. The sensitive data content for the considered use cases is represented by the tuple of temporal and spatial data which un-anonymized allows for the exact location of the data creator at an exact point in time. Present state of the art technologies, therefore, shift the extracted data by an additive constant with respect to time or space. The goal, thereby, is to decouple the time and space tuple and further hide the identity of the data creator in an anonymization group that aggregates data from several sources/creators. The amount of the applied temporal or spatial shift can depend on the traffic density. The shift may be increased with decreasing traffic density and vice versa decreased with increasing traffic density.

Although the anonymization approach of pure temporal shifts has undergone several iterations improving, e.g., the quality of the resulting anonymized data, current state of the art spatial anonymization techniques lack optimization.

Presently, spatial anonymization is based on static grid structures with predefined grid sizes which do not allow for arbitrary dynamic adjustments based on the underlying traffic density. This circumstance usually results in less accurate applications as the required level of data granularity is mostly not met in such a framework, finally ruling out certain use cases.

On the other hand, the static grid spatial anonymization approach also neglects sparsely populated areas which typically imply small traffic densities. This is due to the predefined grid sizes that do not exceed a certain limit. As a result, data extracted in such areas usually is bound to deletion as anonymization fails.

Furthermore, current spatial anonymization techniques lack runtime optimization. Besides, current spatial anonymization techniques have to process big data loads. Since most use cases in consideration rely on big vehicle fleets, the state of the art spatial anonymization struggles to meet this requirement.

### SUMMARY

A need exists to provide an improved method for dynamic spatial anonymization of vehicle data in a cloud environment.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example generic representation of data partitioning using geospatial indexing;

FIG. 2 shows example single vehicle data aggregation;

FIG. 3 shows example multi vehicle data aggregation;

FIG. 4 shows example results of dynamic spatial anonymization for one time interval;

FIG. 5 shows example results of dynamic spatial anonymization for two time intervals;

FIG. 6 shows example overlapping anonymization groups;

FIG. 7 shows example modified anonymization groups; and

FIG. 8 shows example anonymization group representation by corner coordinates;

FIG. 9 shows example modified structure of a reshaped anonymization group; and

FIG. 10 shows example modified structure of a reshaped anonymization group being shifted.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a flexible and/or adaptive method for dynamic spatial anonymization of vehicle data in a cloud environment is provided, which allows for arbitrary sizes and locations of the anonymization areas and does not rely on underlying static grid structures and which serve for enhanced privacy protection, even for sparsely covered areas. In some embodiments, an improved method for dynamic spatial anonymization of vehicle data in a cloud environment is provided, which enhances aggregation techniques and which increases the quality and the reliability of the anonymized data. Moreover some embodiments provide an improved method for dynamic spatial anonymization of vehicle data in a cloud environment, which reduces computational runtime, in particular, in case of big data loads. In some embodiments, a device is provided, especially a backend device, for dynamic spatial anonymization of vehicle data in a cloud environment.

According to the first aspect, embodiments provide a method for dynamic spatial anonymization of vehicle data in a cloud environment with the features of the independent method claim. According to the second aspect, embodiments provide a corresponding computer program product for a respective method with the features of the independent product claim. According to the third aspect, embodiments provide a corresponding device, especially backend device, for dynamic spatial anonymization of vehicle data in a cloud environment with the features of the independent device claim. Details and features disclosed on individual aspects also apply to the other aspects and vice versa.

According to the first aspect, embodiments of the invention provide a method for dynamic spatial anonymization of vehicle data in a cloud environment, the method comprising:
(dynamic) collecting vehicle data,
(dynamic) spatial partitioning (may also be called geospatial indexing and/or splitting) the vehicle data into data subsets, especially dynamically, associated with different geographical areas of various sizes and comprising a maximal amount of records within each data subset,
(dynamic) spatial aggregation of (may also be called compiling and/or combining) the vehicle data within the data subsets, providing two level aggregation:
first level aggregation of vehicle data (within a data subset), coming from a single vehicle (within an associated geographical area), to a corresponding data point and
second level aggregation of data points, coming from a group of vehicles (anonymization group) comprising a particular number of vehicles (within an associated geographical area), to a spatial aggregated data set,
optionally modifying (and/or distorting) the spatial aggregated data sets in order to reduce overlapping of the spatial aggregated data sets.

The method may be executed by an external device, such as a backend device in the cloud, in order to save computational power on the vehicle's side and to provide enhanced computational resources for dynamic spatial anonymization of vehicle data.

The actions of the method may be carried out in the given order or in a modified order. Individual actions of the method may be carried out simultaneously and/or repeatedly to allow a flowing process.

For collecting vehicle data, a plurality of participating vehicles may send vehicle data, for example in the form of records and/or measurements, for example comprising sensor data, such as environmental data, temperature values, humidity values, rain intensity, slipping coefficient, etc., and spatial data, such geographical coordinates, to the external device. The vehicle data may also comprise time stamps.

The collecting of vehicle data may be done periodically, for example over a time interval. The time interval may be determined by a performing device, for example individually for different vehicle services, such as navigation services, map services and/or forecast services etc. Each time, after collecting vehicle data within one time interval, the vehicle data will be anonymized before further use, for example for storing, processing and/or providing vehicle services.

The spatial partitioning within the meaning of the present disclosure may also be explained as splitting over geographical areas. The spatial partitioning of the vehicle data may be for example used for reducing the amount of records intended to be anonymized in one execution.

Vehicle data aggregation within the meaning of the present disclosure may also be explained as compiling of vehicle data with intent to prepare aggregated (or combined) data sets for further data processing. The spatial aggregation may be for example used for anonymization of the vehicle data, especially within a current time interval, within a corresponding data subset and/or within an associated geographical area.

The presented method solves the above-mentioned problems of static grid sizes and handling of great amounts of data by spatial anonymization approaches. The presented method may be based on a dynamic approach that allows for both dynamic adjustment of grids and dynamic partitioning of big data loads.

In the case of vehicle application, there are massive amounts of geo-related data, which cannot be efficiently anonymized all in one execution. To overcome this challenge, the vehicle data may be splitted spatially by applying geospatial indexing. Geospatial indexing will be described in the following.

### I Spatial Partitioning

Geospatial indexing is the process of partitioning areas of the earth into identifiable grid cells. Geospatial indexing may be faster than indexing to areas with static grid sizes.

For spatial partitioning within the present disclosure, especially using geospatial indexing, the world and/or a geographical region of interest may be divided into geographical areas with different resolutions, for example starting from 0 until 15. Resolution may be defined as a number of records over a geographic extent of the area. Each area for each resolution gets its own unique ID. Thus, each data subset within an associated geographical area gets the same ID.

For spatial partitioning within the present disclosure, especially using geospatial indexing, following conditions may be provided for splitting the records into subsets:
1. Each data subset comprises a maximal amount (N) of records. The maximal amount of records may be chosen based upon computational capacity constraints of the performing device, such as a backend device in the cloud.
2. Each data subset is denoted by a unique ID. Each unique ID of data subsets correspond to the unique ID of associated geographical areas. The IDs of data subsets within the present disclosure may be represented by the counter.

For spatial partitioning within the present disclosure, especially using geospatial indexing, following actions may be executed:
I.1. For each time interval in which spatial anonymization should be performed iteratively over geo-coordinates starting from the resolution 0 (highest resolution level).
I.2. If found any geographical area comprising a corresponding data subset which has less than N records, then assign unique ID to this data subset.
I.3. Identify geographical areas comprising corresponding data subsets which have more than N records.
I.4. Split the geographical areas comprising corresponding data subsets which have more than N records with an incremental resolution which is now 1.
I.5. Repeat steps I.2, I.3 and I.4 until all records are assigned to geographical areas comprising corresponding data subsets which have less than N records or until the resolution reaches a maximal available value, for example 15.

### II Spatial Aggregation, Comprising for Example Two Level Aggregation

The dynamic spatial anonymization follows for example a two level aggregation approach.

Vehicle data aggregation may further for example use the information advantage that is available for non-anonymized data prior to anonymization.

Vehicle data aggregation provides a combination of multiple vehicle data, records and/or measurements aggregated to a lower number of values, and thus providing anonymization,
first level i aggregation within vehicle data from every single vehicle,
   for example reducing the effect of sensor noise, for example removing data outliers, and/or highlighting some unusual measurement of interest.
second level j aggregation within vehicle data coming from several vehicles in the same area combined to groups of k-members, so-called anonymization groups.

Thus, the amount of vehicle data to be anonymized in one execution may be considerably reduced with the help of spatial aggregation.

By assuming that the information measured from a single vehicle does not vary significantly in a certain time interval, and the sensor sampling frequency is higher than needed, it is possible to aggregate the data coming from a single vehicle without losing significant information. Thus, the relevant information may be reliably maintained.

For example, by collecting temperature measurements in a certain area, the temperature sampling frequency on the vehicle may be 1 Hz. It may be possible to aggregate together the temperature information provided from a single vehicle in the same time interval, e.g. 10 s, without losing relevant information. The temperature usually does not change significantly within in 10 s. Also, the vehicle displacement in such a time interval may be neglected for the specific use-case, but the amount of data to process is 10 times smaller.

For example, while collecting rain intensity measurements, it may happen that the vehicle passes under some roof, bridge or tree. In this case these unusual measurements may be considered as an outlier in the 10 s time window. The data aggregation may for example filter out the effects of such outliers.

The data aggregation may also highlight some uncommon measurements. For example, by collecting the slipping coefficient of the road in a certain area, in a certain time, due to ice slabs on the street, it is possible to take into account each single ice slab on the road, even if small.

Aggregated data in this case will contain the information about the “ice”, even if for most of the 10 s time interval there was no ice on the road.

Thus, the data quality may be improved with the help of filtering and/or highlighting the vehicle data.

In general for each sensor type, signal source and/or data type, a different aggregation methodology may be applied that has proven to be valuable for the specific cases. Aggregation methodologies comprehend statistical indicators (mean, max, n-th percentile, etc. . . . ), a combination of them, or functions implemented ad hoc for the specific use-case.

Thus, quality and reliability of data can be improved prior to anonymization.

A second level of aggregation may be then performed between measurements coming from a set of several vehicles in the same time interval and in the same area. This second step of aggregation allows to reach the anonymization goal, because from the aggregated data it would be extremely unlikely to go back to the single vehicle that contributed to the aggregated data.

Still on the other hand, spatial anonymization approach which may use dynamic spatial anonymization may lead to overlapping of spatial aggregated data sets. With other words a single vehicle contributing to more than one spatial aggregated data set may then be re-identified with some probability.

Therefore, in some embodiments, the spatial aggregated data sets can be modified (and/or distorted) in order to reduce overlapping of the spatial aggregated data sets.

As a result, in such embodiments, the method is improved with regard to enhanced privacy protection, especially for geographical areas in which vehicles may be multiply arranged to different anonymization groups, so that vehicles may contribute for more than one spatial aggregated data set. It may for example occur during second level aggregation, so that the spatial aggregated data sets may obtain overlapping portions.

The inventors have recognized that the second level aggregation may cause scenarios in which the anonymization groups may obtain common participants. Common participants within the anonymization groups may result in unauthorized tracing of these participants. The anonymity of such participants may be at risk. More precisely, overlapping portions of the spatial aggregated data sets may be assigned with higher probability of data creation than other portions, resulting in a potential privacy risk.

The aforementioned embodiments address this circumstance to avoid such scenarios allowing for unauthorized tracing of vehicles as data sources. As a result, the method optimizes privacy and ensures uniform probability distribution for locating data within the groups of vehicles during second level aggregation, that is during aggregation data points.

To protect the vehicles within the anonymization groups with higher probability, the aforementioned embodiments provide a technique to resolve potentially overlapping portions of spatial aggregated data sets. In such embodiments, the presented method may modify or with other words distort the spatial aggregated data sets by changing the sizes, shapes and/or location of their groups, for example in a random way. The modification of the spatial aggregated data sets prevents privacy risks, since potentially overlapping portions within the spatial aggregated data sets with higher localization probabilities may be destroyed. In particular, the occurrence of potential consecutive series of portions within the spatial aggregated data sets with high localization probabilities may be almost prevented due to this method. At the same time, the anonymization of the data content is still guaranteed as the randomized spatial aggregated data sets contain substantially information aggregated within an almost non-overlapping anonymization group.

Furthermore, it may be beneficial in some embodiments, if the modification of the spatial aggregated data sets may be performed randomly. Thus, a computationally beneficial way to resolve the overlapping may be provided.

Moreover, it may be beneficial in some embodiments, if the modification of the spatial aggregated data sets will be performed through changing size, shape and/or location of the corresponding groups. Thus, for example techniques to modify and/or distort the groups may be provided.

In some embodiments, the vehicle data may for example be collected periodically within a time interval. For example, the time interval may be chosen depending on vehicle service, sensor type, signal source and/or data type. Thus, the properties and requirements of vehicle services and/or evaluable vehicle data may be beneficially taken into account by adapting the dynamic of the spatial anonymization.

The spatial partitioning may be used for reducing the amount of records intended to be anonymized in one execution. The spatial aggregation may be used for anonymization of the vehicle data, especially within a current time interval, within a corresponding data subset and/or within an associated geographical area.

Further, the spatial aggregation may be provided using the k-anonymity methodology. For example, a spatial aggregated data set aggregates data points coming from different vehicles arranged into groups using the k-nearest neighbor method. In this way, effective data protection may be provided with simple techniques and without much computational effort.

Furthermore, it may be beneficial in some embodiments, if a spatial aggregated data set multiply aggregates data points coming from different vehicles, wherein especially some vehicles will be arranged to more than one group. Thus, overlapping groups of vehicles may be provided within an associated geographical area of the corresponding data subset. This allows using data from one vehicle multiple times, thus enlarging the value of data significantly.

For example, the vehicle data may comprise sensor data and spatial data. Hereby the sensor data may comprise environmental data, temperature values, humidity values, rain intensity, slipping coefficient, etc. Therefore, a data point coming from a single vehicle comprises aggregated sensor data and aggregated spatial data for the single vehicle. Thus, a spatial aggregated data set coming from a group of vehicles comprises aggregated sensor data and aggregated spatial data for the group of vehicles.

Vehicle data within a data point may be filtered in order to exclude unusual measurements. Thus, the quality and reliability of the data may be achieved.

Vehicle data within a data point may be highlighted in order to detect environmental effects, such as ice slabs on the street, in highly restricted areas within a particular geographical area. Thus, restricted effects that may not be registered by all participants can still be detected by the method. Therefore, the value of the data may be significantly increased.

For increased functionality and suitability of the method, the spatial aggregation may be performed using different aggregation methodologies for different vehicle services, sensor types, signal sources and/or data types. Hereby, a particular aggregation methodology may be chosen depending on vehicle service, sensor type, signal source and/or data type.

Beneficially, the spatial partitioning may be provided using a method of geospatial indexing. Thus, dynamic adjustment of grids and dynamic partitioning of big data loads may be provided.

Further, it may be possible that the spatial partitioning may be provided using an iterative splitting of an incoming set of records into geographical areas having different resolution levels. Thus, a reduction of big data loads may be provided in an iteratively way.

Furthermore, it may be possible that the spatial partitioning may be provided until a data subset comprises an amount of records lower than the maximal amount of records. Thus, the computational constrains of a performing device may be addressed.

For example, the maximal amount of records may be chosen according to computational capacity of a performing device.

According to a further example aspect, a computer program product is provided, comprising instructions which, when the program is executed by a computer, cause the computer to carry out a method as described above. With the help of the computer program product, the same benefits may be achieved as described above in the context of the method. Full reference is made to these benefits in the present case.

According to a further example aspect, a device, especially backend device, is provided, comprising a memory device in which program code is stored, and a computing device configured to execute the program code, wherein when executing the program code, a method may be performed as described above. With the help of the device, the same benefits may be achieved as described above in the context of the method. Full reference is made to these benefits in the present case.

For example, the memory device may comprise a database for spatial aggregated data sets. With the help of the database, the anonymized vehicle data may be stored und easily used, especially combined with a goal that the individual vehicles cannot be re-identified, while the data remains useful for vehicle services.

Beneficially, the computing device may be configured to provide vehicle services, comprising navigation services, map services and/or forecast services etc., to participating vehicles using the aggregated data sets. Also for example, the computing device may be configured to provide different vehicle services depending on service type, signal source and/or data type. Thus, the different vehicle services may be provided with more quality and increased functionality.

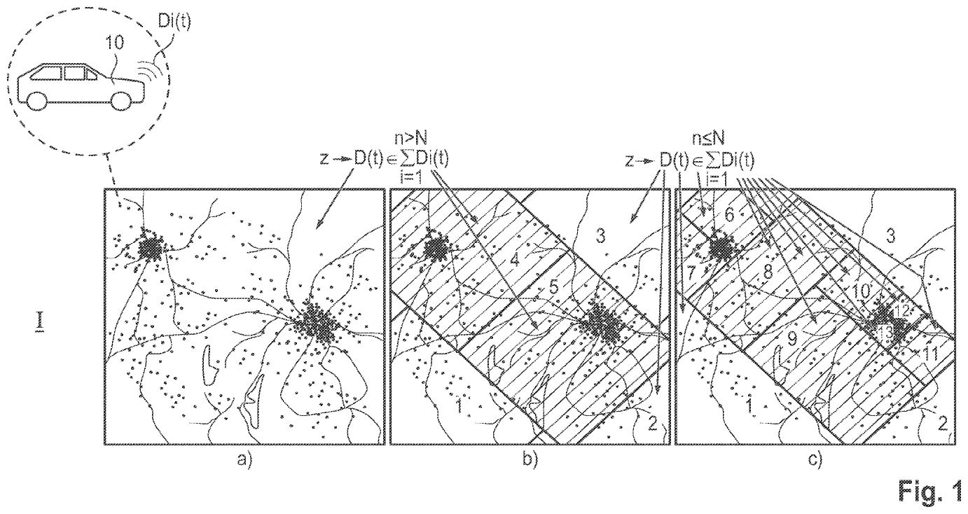

FIG. 1 to 10 serve for explaining an inventive method for dynamic spatial anonymization of vehicle data in a cloud environment,

the method comprising:
0 (dynamic) collecting vehicle data D(t),
I (dynamic) spatial partitioning (or geospatial indexing and/or splitting) the vehicle data D(t) into data subsets DZ(t), especially dynamically, associated with different geographical areas Z of various sizes and comprising a maximal amount N of records within each data subset DZ(t),
II (dynamic) spatial aggregation of (or compiling and/or combining) the vehicle data D(t) within the data subsets DZ(t), providing two level aggregation:
   first level i aggregation of vehicle data Di(t) (within a data subset DZ(t)), coming from a single vehicle (10) (within an associated geographical area Z), to a corresponding data point Di_mean and
   second level j aggregation of data points Di_mean, coming from a group of vehicles 10 comprising a particular number k of vehicles 10 (within an associated geographical area Z), to a spatial aggregated data set Dj_mean,
III optionally modifying the spatial aggregated data sets Dj_mean in order to reduce overlapping of the spatial aggregated data sets Dj_mean.

The method may be executed by an external device 20, such as a backend device in the cloud, in order to save computational power of the vehicle's side and to provide enhanced computational resources for providing improved vehicle services.

The present method provides variable grid sizes and handles great amounts of data in an effective manner. The presented method is based on a dynamic approach that allows for both dynamic adjustment of grids and dynamic partitioning of big data loads.

In the case of vehicle application, there are massive amounts of geo-related data, which cannot be efficiently anonymized all at the same time and/or in one execution. To overcome this challenge, the vehicle data D(t) may be splitted spatially, for example by applying geospatial indexing, as explained in the following and represented in FIG. 1.

### I Spatial Partitioning

For spatial partitioning within the present disclosure, especially using geospatial indexing, the world and/or a geographical region (s. the first representation a in FIG. 1) of interest may be divided into geographical areas with different resolutions. In an example, the resolution may be iterated from 0 to 15. Resolution may be represented by a number of records in a geographic area. The records are shown in FIG. 1 as single points. As the second and the third representations b and c in FIG. 1 show, each area Z for each resolution gets its own unique ID (for example from 1 to 13). Thus, each data subset DZ(t) within an associated geographical area gets the same ID.

For spatial partitioning/geospatial indexing following conditions may be provided for splitting the vehicle data D(t) into subsets DZ(t):
1. Each data subset DZ(t) comprises a maximal amount N of records. The maximal amount N of records may be chosen based upon computational capacity constraints of the performing device 20, such as backend device in the cloud.
2. Each data subset DZ(t) is denoted by a unique ID (s. number Z from 1 to 13 in FIG. 1). Each unique ID of the data subsets DZ(t) corresponds to the unique ID of associated geographical areas Z. Thus, the IDs of data subsets DZ(t) are represented by the counter Z.

As FIG. 1 represents, following actions may be executed for spatial partitioning/geospatial indexing:
I.1 For each time interval in which spatial anonymization should be performed iteratively over geo-coordinates starting from the resolution 0 (highest resolution level, the first representation a in FIG. 1).
I.2 If found any geographical area Z comprising a corresponding data subset DZ(t) which has less than N records, then assign unique ID to this data subset DZ(t).
I.3 Identify (see areas 4 and 5 in the second representation b in FIG. 1) geographical areas Z comprising corresponding data subsets DZ(t) which have more than N records.
I.4 Split the geographical areas Z comprising corresponding data subsets DZ(t) which have more than N records with an incremental resolution which is now 1.
I.5 Repeat steps I.2, I.3 and I.4 until all records are assigned to geographical areas Z comprising corresponding data subsets DZ(t) which have less than N records (the third representation c in FIG. 1) or until the resolution reaches maximal available value, for example 15.

Representation of data partitioning using geospatial indexing shown in FIG. 1 illustrates how the method iteratively splits the incoming vehicle data D(t).
a) Initial vehicle data D(t) collected from participating vehicles 10. This vehicle data D(t) contains more than N records and it is computationally intensive to perform anonymization on it.
b) First step of (dynamic) spatial partitioning (geospatial indexing and/or splitting). Geographical areas Z=1, Z=2 and Z=3 contain less than N records and may be used as input for an efficient execution of the anonymization. Geographical areas Z=4 and Z=5 contain more than N records and need to be further divided in sub-areas.
c) Outcome of (dynamic) spatial partitioning (geospatial indexing and/or splitting). All the areas Z=1, 2, 3, 6, 7, 8, 9, 10, 11, 12, 13 contain less than N records and may be used to perform anonymization in an efficient way providing representative results.

This approach results in dynamic grid sizes that may span in reality from less than 0.01 km² to 100 km², as shown in FIG. 1. In contrast to state of the art methods that only anonymize on fixed grid levels not leveraging the smaller grid sizes that could be possible because of high vehicle coverage in dense, urban areas.

### II Spatial Aggregation, Comprising for Example Two Level i, j Aggregation

The dynamic spatial anonymization follows for example a two level i, j aggregation approach.

Vehicle data aggregation may use the information advantage that is available for non-anonymized vehicle data D(t) prior to anonymization in action II.

Vehicle data aggregation II provides a combination of multiple vehicle data D(t), that is records and/or measurements and/or pints in the view of FIG. 1, aggregated to a lower number of values, and thus providing anonymization,
first level i aggregation within vehicle data Di(t) from every single vehicle 10,
   for example reducing the effect of sensor noise, for example removing data outliers, and/or highlighting some unusual measurement of interest.
second level j aggregation within vehicle data D(t) coming from several vehicles 10 in the same area combined to groups G of k-members, so called anonymization groups.

Thus, the amount of vehicle data D(t) to be anonymized (Dj_mean) in one execution may be considerably reduced with the help of spatial aggregation II.

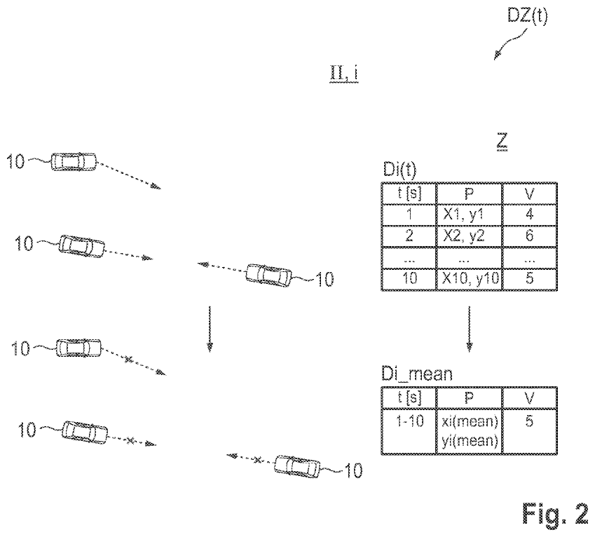

A first level i of aggregation is illustrated in FIG. 2.

By assuming that the vehicle data Di(t) from a single vehicle 10 does not vary significantly in a certain time interval dt, and the sensor sampling frequency is higher than needed, it is possible to aggregate the vehicle data Di(t) coming from a single vehicle 10 without losing significant information. Thus, the relevant information may be reliably maintained within a corresponding data point Di_mean.

For example, by collecting temperature measurements in a certain area Z, the temperature sampling frequency on the vehicle may be 1 Hz. It may be possible to aggregate together the temperature information provided from a single vehicle 10 in the same time interval, e.g. 10 s, without losing relevant information. The temperature usually does not change significantly within in 10 s. Also, the vehicle displacement in such a time interval dt may be neglected for the specific vehicle service, but the amount of data to process by anonymization is 10 times smaller.

For example, by collecting the rain intensity measurements, it may happen that the vehicle 10 passes under some roof, bridge or tree. In this case these unusual measurements may be considered as an outlier in the 10 s time window. The vehicle data D(t) aggregation may for example filter out the effects of such outliers.

The data aggregation may also highlight some uncommon measurements. For example by collecting the slipping coefficient of the road in a certain area, in a certain time, due to ice slabs on the street, it is possible to recognize each single ice slab on the road, even if small. Aggregated data in this case will contain the information about the “ice”, even if for most of the 10 s time-interval there was no ice on the road.

Thus, the data quality may be improved with the help of filtering and/or highlighting the vehicle data D(t).

In general for each sensor type, signal source and/or data type, a different aggregation methodology may be applied that has proven to be valuable for the specific cases. Aggregation methodologies comprehend statistical indicators (mean, max, n-th percentile, etc. . . . ), a combination of them, or functions implemented ad hoc for the specific use-case.

Thus, improving quality and reliability of data prior to anonymization.

In the first step i, time series data Di(t) from single vehicles 10 will be recorded over a time interval dt, comprising positional information (spatial data P) along the trajectory of a vehicle 10 together with recorded information (sensor data V) of the vehicle sensors. As illustrated in FIG. 2 a single vehicle trajectory over a time interval dt, for example from 1 to 10 s, is depicted using arrows, where every dot stands for a single recorded spatial data P and a corresponding sensor data V. This vehicle trajectory is then aggregated into one data point Di_mean illustrated using the cross. The vehicle data Di(t) from vehicles 10 will be aggregated into corresponding data points Di_mean containing only an aggregate. Thus, no exact position (spatial data P) but only an aggregation of the perceived sensor data V will be maintained within the data points Di_mean.

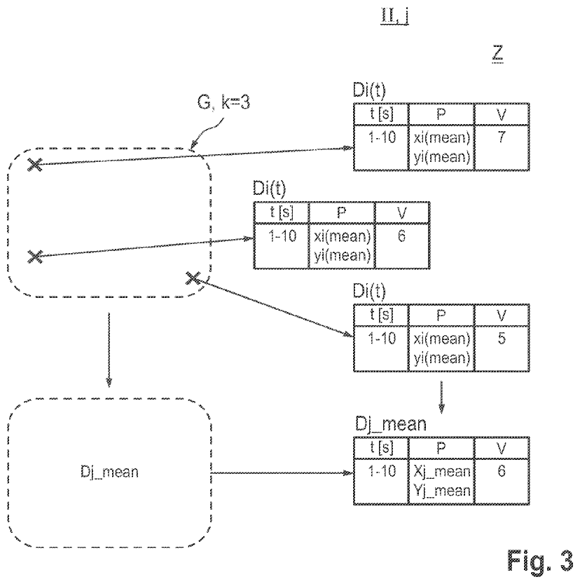

A second level j of aggregation is illustrated in FIG. 3.

A second level j of aggregation is thus performed within a set of vehicles 10 in the same time interval dt and in the same geographical area Z. This second step j of aggregation allows to reach the anonymization goal, because from the aggregated data it would be extremely unlikely to go back to the single vehicle 10 that contributed to the aggregated data set Dj_mean.

In the second step j of the spatial anonymization following the k-anonymity methodology, multiply aggregated data points Di_mean coming from different vehicles 10 will be arranged in groups G of k vehicles 10, for example using the k nearest neighbor method. Data of these groups G of k vehicles 10 (for example k=3) are then aggregated again leaving only information about the portion of the geographical area Z where the group G of vehicles were located in and aggregate values. The number of groups G may be smaller than the number of vehicles 10 in the corresponding geographical area Z.

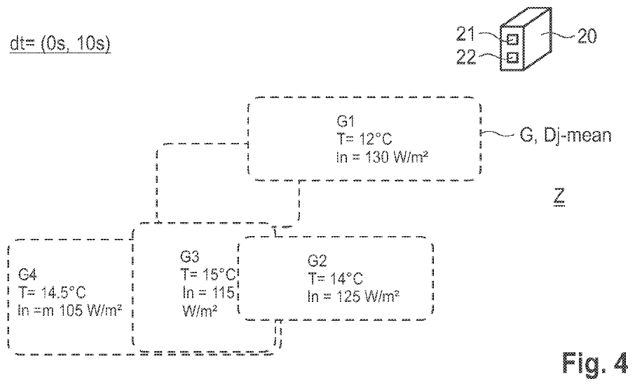

FIG. 4 illustrates the result over a time interval dt from 0 to 10 s for groups G1, G2, G3, G4, . . . . FIG. 4 shows varying sizes and overlapping portions of the resulting spatial aggregated data sets Dj_mean. As can be seen from FIG. 4, overlapping groups G of vehicles 10 may be provided within an associated geographical area Z of the corresponding data subset DZ(t). This allows using data from some vehicles 10 multiple times. Thus, the value of data may be enlarged significantly.

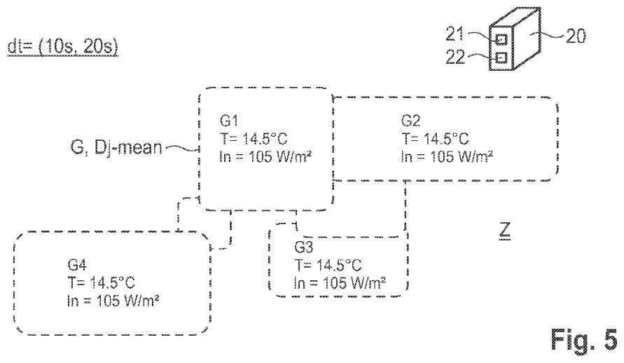

FIG. 5 illustrates the result over a time interval dt from 10 to 20 s, following the time interval dt of FIG. 4, for groups G1, G2, G3, G4, . . . . Comparing FIGS. 4 and 5, it may be seen, that for every time interval dt new spatial bounding boxes, that is new groups G, comprising different vehicles 10 will be formed grouping the spatially closest vehicles 10 together.

By following the dynamic spatial anonymization, vehicle data D(t) may be fully anonymized within flexible determined geographical areas Z following the methodology of k-anonymity and for example the k-nearest neighbor grouping/classification.

The dynamic feature of spatial partitioning I allows for arbitrary sizes and locations of the anonymization areas Z.

With the help of the integrating spatial aggregation II, the data quality enhancing aggregation techniques, the reliability of the anonymized data output may be increased.

Furthermore, the presented method, combining both techniques: spatial partitioning I and spatial aggregation II, reduces computational runtime, in particular, in case of big data loads and results in an enhanced privacy protection, even for sparsely covered areas that may now be incorporated within the dynamic grid approach.

The present method, especially the action III of the method, is improved with regard to enhanced privacy protection, especially for geographical areas Z having a relative high number of data sources. In such areas Z a single vehicle 10 may be multiply arranged to different groups G. In this case, the spatial aggregated data sets Dj_mean may overlap. The overlapping of the spatial aggregated data sets Dj_mean may result in unauthorized tracing of overlapping portions and thus of vehicles 10 contributing as data sources. The anonymity of vehicles 10 may be endangered. More precisely, the overlapping portions of the spatial aggregated data sets Dj_mean may be tracked with higher probability than other portions in the groups G, resulting in a potential privacy risk for contributing vehicle 10.

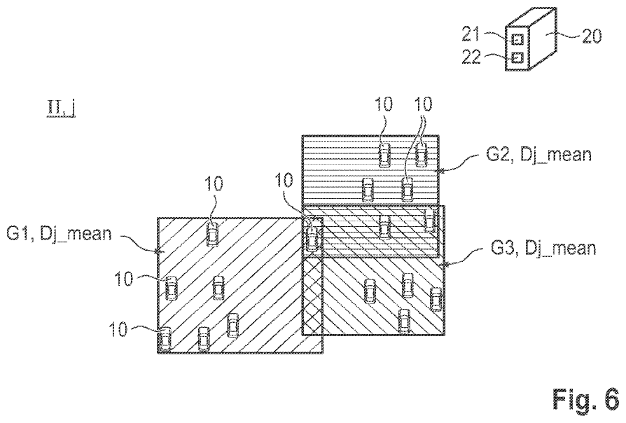

Such a scenario is illustrated in FIG. 6, where for example the minimal group size is 7 vehicles 10. Different groups G1, G2, G3 are achieved in three different positions. Although within each group G1, G2, G3, the identity of vehicles as data sources is hidden in a group, the combination of all three groups G1, G2, G3 yields an overlapping area of much smaller size than the original group sizes. FIG. 6 shows a probable case of only a single vehicle 10 as a data creator originally providing information in this small intersection portion. In case of a consecutive series of such scenarios of overlapping portions, this might result in a reduction of privacy.

The present method addresses this circumstance to avoid such scenarios allowing for unauthorized tracing of vehicles 10. The present method optimizes privacy and ensures uniform probability distribution for locating data within the groups of vehicles during the second level aggregation j, that is during aggregation data points Di_mean.

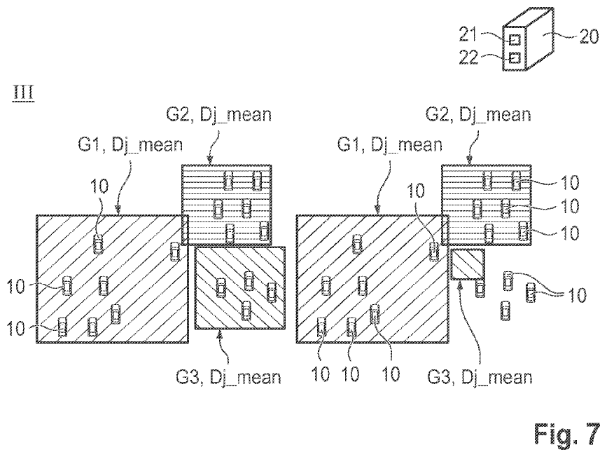

As FIG. 7 illustrates especially the action III of the method, according to which, a technique to resolve potentially overlapping portions of spatial aggregated data sets Dj_mean is provided. This technique serves to protect the vehicles 10 within the groups G with higher probability, through the modification the spatial aggregated data sets Dj_mean. The modification may be made for example through changing sizes, shapes and/or locations of the corresponding groups G, for example in a random way. The modification of the spatial aggregated data sets Dj_mean prevents privacy risks, since potentially overlapping portions with higher localization probabilities may be avoided. Especially, the occurrence of potential consecutive series of portions within the spatial aggregated data sets Dj_mean with high localization probabilities may be almost prevented due to this method. At the same time, the reliability of data content is still guaranteed as the randomized spatial aggregated data sets Dj_mean contain substantial information aggregated within an non-overlapping anonymization group G.

In detail, the modification of the spatial aggregated data sets Dj_mean may be provided as follows:

Let v be a vector describing a specific anonymization group G, e.g. v may be composed of the geo-coordinates of the corners of the anonymization group G:

$$v = \{ ( x 1 , y 1 ) , ( x 2 , y 2 ) , ( x 3 , y 3 ) , ( x 4 , y 4 ) \} :$$

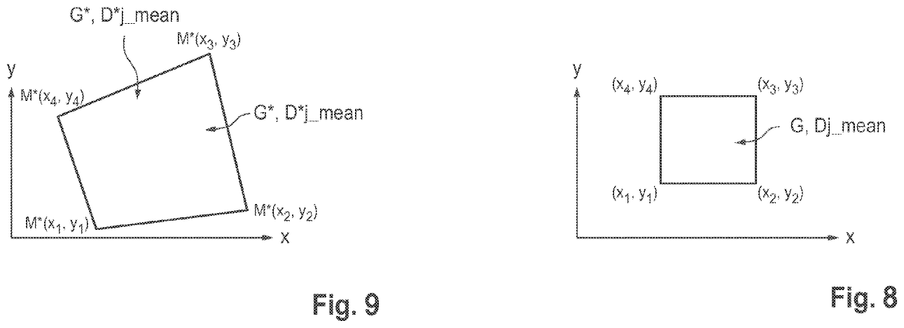

FIG. 8 illustrates group representation by corner coordinates.

Let further M be a 2×2 Matrix of the form:

$$M = ( \begin{matrix}r 1 & 0 \\ 0 & r 2\end{matrix} ) ,$$

with r1 and r2 being random numbers in a certain interval, e.g. [−1, 1]. Then, M will perform a modification of length, shape and/or orientation when applied to a vector (x, y) depending on the values r1 and r2.

If a modifying matrix:

$${M}^{*} = ( \begin{matrix}M & 0 & 0 & 0 \\ 0 & M & 0 & 0 \\ 0 & 0 & M & 0 \\ 0 & 0 & 0 & M\end{matrix} )$$

will be applied to v, which describes an anonymization group G, it will result in a squeezed or stretched anonymization group G*. Thus, the modified spatial aggregated data set D*j_mean is created.

FIG. 9 illustrates a modified anonymization group G* and corresponding modified spatial aggregated data set D*j_mean.

To also shift the group G, a shift vector tshift may be added to v, for example as:

$${v}^{*} = {M}^{*} \cdot v + t shift .$$

The shift vector t may be a random vector. However, it may be for example, if the shift vector t may be chosen within predefined thresholds, e.g. in an interval between 0 and 500 meters. The choice of the shift vector tshift may be made for example depending on the resolution of the current geographical area Z. Also, the requirements of the current use-case may be considered by the choice of the shift vector t.

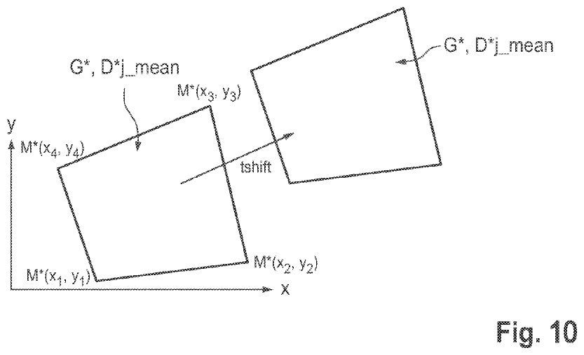

FIG. 10 depicts the modified anonymization group G* and corresponding modified spatial aggregated data set D*j_mean being additionally shifted by the shift vector t.

Therefore, privacy within the dynamic spatial anonymization framework may be enhanced. The present method serves for example for dynamic anonymization of the provided data content and at the same time ensures maximal protection of the identity of each data creator. The presented method may for example utilize a randomization approach.

A computer program product comprising a program code for carrying out a method as described above provides an aspect of the invention.

Also, a device 20, especially backend device, provides an aspect of the invention. The device 20 is only shown schematically in FIGS. 4 and 5. The device 20 comprises a memory device 21 in which program code is stored, and a computing device 22 configured to execute the program code, wherein when executing the program code, a method may be performed as described above. The memory device 21 may further comprise a database for spatial aggregated data sets Dj_mean. The computing device 22 may be configured to provide vehicle services, comprising navigation services, map services and/or forecast services etc., to participating vehicles 10 using the aggregated data sets Dj_mean. Furthermore, the computing device 22 may be configured to provide different vehicle services depending on service type, signal source and/or data type.

The above description of the figures describes the present invention only in the context of examples. Of course, individual features of the embodiments may be combined with each other, provided it is technically reasonable, without leaving the scope of the invention.

LIST OF REFERENCE SIGNS

| | |
|---|---|
| 10 | vehicle |
| 20 | device |
| 21 | memory device |
| 22 | computing device |
| t | time |
| dt | time interval |
| D(t) | vehicle data |
| DZ(t) | data subsets |
| N | a maximal amount of records within a data subset |
| Di(t) | vehicle data, coming from a single vehicle |
| Di_mean | data point |
| G | group, anonymization group |
| G* | modified anonymization group |
| k | particular number of vehicles within a group |
| Dj_mean | aggregated data set |
| D*j_mean | modified aggregated data set |
| G1 | group |
| G2 | group |
| G3 | group |
| G4 | group |
| T | temperature |
| In | light intensity |
| P | spatial data |
| V | sensor data |
| Z | geographical areas |
| x | coordinate, |
| x1 | coordinate |
| x2 | coordinate |
| x3 | coordinate |
| x4 | coordinate |
| y | coordinate |
| y1 | coordinate |
| y2 | coordinate |
| y3 | coordinate |
| y4 | coordinate |
| M | matrix |
| M* | modifying matrix |
| tshift | shift vector |

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

e functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-20. (canceled)

21. A method for dynamic spatial anonymization of vehicle data in a cloud environment, the method comprising:
collecting vehicle data;
spatial partitioning of the vehicle data into data subsets, associated with different geographical areas of various sizes and comprising a maximal amount of records within each data subset;
spatial aggregation of the vehicle data within the data subsets, providing two level aggregation:
aggregation of vehicle data, coming from a single vehicle, to a corresponding data point; and
aggregation of data points, coming from a group of vehicles comprising a particular number of vehicles, to a spatial aggregated data set.

22. The method of claim 21, wherein the method additionally comprises modifying the spatial aggregated data sets in order to reduce overlapping of the spatial aggregated data sets.

23. The method of claim 22, wherein modification of the spatial aggregated data sets will be performed randomly, and/or
wherein modification of the spatial aggregated data sets will be performed through changing the size, the shape and/or the location of the corresponding groups of vehicles.

24. The method of claim 21, wherein the vehicle data will be collected periodically with a time interval,
wherein especially the time interval is chosen depending on vehicle service, sensor type, signal source and/or data type, and/or
wherein spatial partitioning is used for reducing the amount of records intended to be anonymized in one execution, and/or
wherein the spatial aggregation is used for anonymization of the vehicle data, especially within a current time interval, within a corresponding data subset and/or within an associated geographical area.

25. The method of claim 21, wherein the spatial aggregation is provided using the k-anonymity methodology, and/or
wherein a spatial aggregated data set aggregates data points coming from different vehicles arranged into groups using the k-nearest neighbor method.

26. The method of claim 21, wherein a spatial aggregated data set multiply aggregates data points coming from different vehicles, wherein some vehicles will be arranged to more than one group.

27. The method of claim 21, wherein the vehicle data comprise sensor data and spatial data, and/or
wherein sensor data comprise one or more of environmental data, temperature values, humidity values, rain intensity, and slipping coefficient, wherein a data point coming from a single vehicle comprises aggregated sensor data and aggregated spatial data for the single vehicle, and/or
wherein a spatial aggregated data set coming from a group of vehicles comprises aggregated sensor data and aggregated spatial data for the group of vehicles.

28. The method of claim 21, wherein vehicle data within a data point will be filtered in order to exclude unusual measurements.

29. The method of claim 21, wherein vehicle data within a data point will be highlighted in order to detect environmental effects, such as ice slabs on the street, in highly restricted areas within a particular geographical area.

30. The method of claim 21, wherein the spatial aggregation is performed using different aggregation methodologies for different vehicle services, sensor types, signal sources and/or data types, and/or
wherein a particular aggregation methodology is chosen depending on vehicle service, sensor type, signal source and/or data type.

31. The method of claim 21, wherein the spatial partitioning is provided using a method of geospatial indexing.

32. The method of claim 21, wherein the spatial partitioning is provided using an iterative splitting of incoming sets of records into geographical areas having different resolution levels, and/or
wherein the spatial partitioning is provided until a data subset comprise an amount of records lower than the maximal amount of records.

33. The method of claim 21, wherein the maximal amount of records will be chosen according to computational capacity of a performing device.

34. A non-transitory storage medium comprising instructions which, when the instructions are executed by a computer, cause the computer to conduct:
collecting vehicle data;
spatial partitioning the vehicle data into data subsets, associated with different geographical areas of various sizes and comprising a maximal amount of records within each data subset; and
spatial aggregation of the vehicle data within the data subsets, providing two level aggregation:
aggregation of vehicle data, coming from a single vehicle, to a corresponding data point; and
aggregation of data points, coming from a group of vehicles comprising a particular number of vehicles, to a spatial aggregated data set.

35. A device, comprising:
memory in which program code is stored, and
a processor configured to execute the program code, wherein executing the program code causes the processor to conduct:
collecting vehicle data;
spatial partitioning the vehicle data into data subsets, associated with different geographical areas of various sizes and comprising a maximal amount of records within each data subset; and
spatial aggregation of the vehicle data within the data subsets, providing two level aggregation:
aggregation of vehicle data, coming from a single vehicle, to a corresponding data point; and
aggregation of data points, coming from a group of vehicles comprising a particular number of vehicles, to a spatial aggregated data set.

36. The device claim 35, wherein the memory comprises a database for spatial aggregated data sets.

37. The device claim 35, wherein the processor is configured to provide vehicle services, comprising navigation services, map services and/or forecast services etc., to participating vehicles using the aggregated data sets, and/or
wherein the processor is configured to provide different vehicle services depending on service type, signal source and/or data type.

38. The method of claim 22, wherein the vehicle data will be collected periodically with a time interval,
wherein especially the time interval is chosen depending on vehicle service, sensor type, signal source and/or data type, and/or
wherein spatial partitioning is used for reducing the amount of records intended to be anonymized in one execution, and/or
wherein the spatial aggregation is used for anonymization of the vehicle data, especially within a current time interval, within a corresponding data subset and/or within an associated geographical area.

39. The method of claim 23, wherein the vehicle data will be collected periodically with a time interval,
wherein especially the time interval is chosen depending on vehicle service, sensor type, signal source and/or data type, and/or
wherein spatial partitioning is used for reducing the amount of records intended to be anonymized in one execution, and/or
wherein the spatial aggregation is used for anonymization of the vehicle data, especially within a current time interval, within a corresponding data subset and/or within an associated geographical area.

40. The method of claim 22, wherein the spatial aggregation is provided using the k-anonymity methodology, and/or
wherein a spatial aggregated data set aggregates data points coming from different vehicles arranged into groups using the k-nearest neighbor method.
